(19) United States
(12) Patent Application Publication
(10) Pub. No.: US 2021/0162547 A1
(43) Pub. Date: Jun. 3, 2021

(54) MANUFACTURING METHOD OF CUT FILM, CUT FILM, AND FILM FOR CUT FILM

(71) Applicant: ZEON CORPORATION, Chiyoda-ku, Tokyo (JP)

(72) Inventor: Satoshi YAMADA, Tokyo (JP)

(73) Assignee: ZEON CORPORATION, Chiyoda-ku, Tokyo (JP)

(21) Appl. No.: 17/265,809

(22) PCT Filed: Aug. 8, 2019
(86) PCT No.: PCT/JP2019/031464

§ 371 Date: Feb. 4, 2021

(30) Foreign Application Priority Data
Aug. 20, 2018 (JP) 2018-154161

(51) Int. Cl. B23K 26/38; B23K 26/40

(52) U.S. Cl. CPC B23K 26/38; G02B 5/3041; B23K 26/40

(57) ABSTRACT

A method for producing a cut film comprising cutting a pre-cut film including a resin layer with a laser beam having a wavelength of 400 nm or longer and 850 nm or shorter to obtain a cut film, wherein the pre-cut film has an absorbance, at a wavelength of the laser beam, of 0.10 or less.

### FIELD

The present invention relates to a method for producing a cut film, a cut film, and a film for a cut film.

### BACKGROUND

A film including a resin layer (hereinafter also referred to as a resin film) is used as an optical film or the like included in an image display device or the like. In recent years, there is a growing demand for accurately processing the resin film in accordance with, for example, a shape of the final product. As a processing method of the resin film, a processing method using a laser beam is used (Patent literatures 1 to 3) as it can achieve more accurate processing as compared with mechanical cutting using a knife or the like.

### CITATION LIST

### Patent Literature

Patent Literature 1: Japanese Patent Application Laid-Open No. 2018-052082 A

Patent Literature 2: Japanese Patent Application Laid-Open No. 2006-108165 A

Patent Literature 3: Japanese Patent Application Laid-Open No. 2016-057403 A

### SUMMARY

### Technical Problem

When a resin film is cut with a laser beam, a laser processing affected portion is usually formed around the cut surface. The laser processing affected portion described herein refers to a portion where a resin layer included in the resin film cut by the laser beam is deformed by heat generated during cutting. The deformation of the resin layer described above includes both increasing and decreasing of the thickness of the resin layer. Further, the cutting includes punching a hole. When such a laser processing affected portion has a large width, it may cause bulging of the end portion of the resin film, size changes, and the occurrence of wrinkles. Thus, as a film cutting method using a laser beam, there is a demand for developing a method capable of cutting a film while minimizing the width of the laser processing affected portion.

Specifically, there are demands for a method for producing a cut film having a small width of a laser processing affected portion by cutting a pre-cut film including a resin layer using a laser beam; a cut film having a small width of a laser processing affected portion; and a film for a cut film for obtaining a cut film having a small width of a laser processing affected portion.

### Solution to Problem

The present inventor has intensively conducted research in order to solve the aforementioned problems. As a result, the present inventor has found that the aforementioned problems can be solved by cutting a film having an absorbance within a particular range using a laser beam having a wavelength within a particular range, thereby completing the present invention. That is, the present invention provides as follows.

[1] A method for producing a cut film comprising cutting a pre-cut film including a resin layer with a laser beam having a wavelength of 400 nm or longer and 850 nm or shorter to obtain a cut film, wherein the pre-cut film has an absorbance, at a wavelength of the laser beam, of 0.10 or less.

[2] The method for producing a cut film according to [1], wherein the laser beam is a second harmonic of a YAG laser device.

[3] The method for producing a cut film according to [1] or [2], wherein the laser beam is pulsed light having a pulse width of less than 1 μs.

[4] The method for producing a cut film according to any one of [1] to [3], wherein the resin layer is a layer of an alicyclic structure-containing resin.

[5] The method for producing a cut film according to any one of [1] to [4], wherein a thickness of the pre-cut film is 200 nm or less.

[6] The method for producing a cut film according to any one of [1] to [5], wherein the pre-cut film further includes a polarizer layer.

[7] A cut film that has been cut by a laser beam, wherein
the cut film includes a resin layer,
the laser beam has a wavelength of 400 nm or longer and 850 nm or shorter, and the cut film has an absorbance, at the wavelength of the laser beam, of 0.10 or less.

[8] The cut film according to [7], further comprising a polarizer layer.

[9] A film for a cut film for obtaining a cut film by performing cutting with a laser beam having a wavelength of 400 nm or longer and 850 nm or shorter, wherein the film for a cut film comprises a resin layer, and the film for a cut film has an absorbance, at the wavelength of the laser beam, of 0.10 or less.

### Advantageous Effects of Invention

According to the present invention, there are provided a method for producing a cut film having a small width of a laser processing affected portion by cutting a pre-cut film including a resin layer using a laser beam; a cut film having a small width of a laser processing affected portion; and a film for a cut film for obtaining a cut film having a small width of a laser processing affected portion.

### BRIEF DESCRIPTION OF DRAWINGS

FIG. 1 is a cross-sectional view schematically illustrating a cut film produced from a pre-cut film including a resin layer.

FIG. 2 is a cross-sectional view schematically illustrating a cut film produced from a pre-cut film including a resin layer and a polarizer layer.

### DESCRIPTION OF EMBODIMENTS

Hereinafter, the present invention will be described in detail with reference to embodiments and examples. However, the present invention is not limited to the following embodiments and examples, and may be freely modified for implementation without departing from the scope of claims of the present invention and the scope of their equivalents.

In the following description, a “long-length” film refers to a film with a length that is 5 times or more the width, and preferably a film with the length that is 10 times or more the width, and specifically refers to a film having a length that allows a film to be wound up into a rolled shape for storage or transportation. The upper limit of the length of the film is not particularly limited and may be, for example, 100,000 times or less the width.

In the following description, a description will be given by referring to an example in which a pre-cut film is placed horizontally and irradiated with a laser beam from a direction perpendicular to the horizontally placed film. Thus, the “horizontal direction” refers to a direction parallel to the surface of the pre-cut film unless otherwise specified.

[1. Summary of Production Method of Cut Film]

A method for producing a cut film of the present embodiment includes cutting a pre-cut film including a resin layer with a laser beam having a wavelength of 400 nm or longer and 850 nm or shorter to obtain a cut film. According to the method for producing a cut film of the present embodiment, a width of a laser processing affected portion of the cut film can be reduced.

[1.1. Laser Beam Used for Cutting]

The wavelength of the laser beam used for cutting is normally 400 nm or longer and 850 nm or shorter. The wavelength of the laser beam is preferably 450 nm or longer and more preferably 500 nm or longer, and is preferably 800 nm or shorter, and more preferably 600 nm or shorter.

When the wavelength of the laser beam falls within the aforementioned range, the width of the laser processing affected portion of the cut film can be reduced even if the absorbance of the pre-cut film is low.

The wavelength of the laser beam is particularly preferably a wavelength of the second harmonic of an Yttrium-Aluminum-Garnet (YAG) laser device. The second harmonic of the YAG laser device is normally at around 532 nm, and preferably at 532 nm.

The wavelength range of the aforementioned laser beam is in a visible light region, allowing an operator of the device to recognize a trajectory of the laser beam during the cut processing. This makes it possible to precisely perform the cut processing.

The laser device may be attached with a cover for blocking the laser beam emitted from the laser device. A cover may be attached to an object not being a cutting target for protecting the object from the laser beam. As such a cover, a commonly used colored material that absorbs light in the visible light region can be used, and thus the cut film can be produced inexpensively.

The laser beam is preferably pulsed light having a pulse width of less than 1 μs. Such pulse light having a high peak output can easily cause an ablation phenomenon and thus relatively reduce an effect of heat on the cut surface as compared with a continuous wave laser beam and a laser beam having a pulse width of 1 μs or more. As a result, the width of the laser processing affected portion of the cut film can be effectively reduced. The pulse width of the laser beam is more preferably 100 ns or less, further preferably 50 ns or less, and particularly preferably 1 ns or less, and is normally more than 0 s.

The average output (intensity) of the laser beam is preferably 0.01 W or more, more preferably 0.1 W or more, and further preferably 1 W or more, and is preferably 1 kW or less, more preferably 100 w or less, and further preferably 50 W or less. When the average output (intensity) of the laser beam is equal to or more than the lower limit value of the aforementioned range, the pre-cut film can be quickly cut. Further, when the average output is equal to or less than the upper limit value, the width of the laser processing affected portion of the cut film can be effectively reduced.

[1.2. Pre-Cut Film]

The pre-cut film is an object to be cut by the production method of the present embodiment. The pre-cut film includes a resin layer.

(Pre-Cut Film)

The pre-cut film has an absorbance, at a wavelength of the laser beam for cutting the pre-cut film, of 0.10 or less.

Conventionally, when a film having a low absorbance at the wavelength of the laser beam for cutting the film is cut, the intensity of the laser beam needs to be very large Thus, the cut surface is strongly affected by heat. Accordingly, it has been considered that it is difficult to cut the film with high accuracy in this case.

In the present embodiment, by using a laser beam in a particular wavelength range and cutting a pre-cut film of which the absorbance at the wavelength of the laser beam is 0.10 or less, it is possible to reduce the width of the laser processing affected portion of the cut film unexpectedly.

The absorbance of the pre-cut film at the wavelength of the laser beam used is preferably 0.08 or less, and more preferably 0.06 or less, and is usually 0 or more, and may be more than 0 and may be 0.01 or more. When the absorbance of the pre-cut film is within the aforementioned range, the width of the laser processing affected portion of the cut film can be effectively reduced

The absorbance of the pre-cut film shows the absorption of light penetrating the pre-cut film from one side thereof to the other side thereof.

An absorbance at the wavelength of the laser beam can be measured by a conventionally known method, and may be measured, for example, by an ultraviolet-visible spectrophotometer (for example, “UV-1800” manufactured by Shimadzu Corporation).

The pre-cut film may be a long-length film or a sheet-type film, and is preferably a long-length film. Further, the pre-cut film may be a film having a single layer structure including only one layer, and may be a film having a multilayer structure including two or more layers.

For example, the pre-cut film may be a film including a polarizer layer as an optional layer in addition to the resin layer.

Examples of the polarizer layer may include a film obtained by subjecting a film of a suitable vinyl alcohol-based polymer such as polyvinyl alcohol or partially formalized polyvinyl alcohol to an appropriate treatment such as a dyeing treatment with iodine and a dichroic substance such as a dichroic dye, a stretching treatment, or a crosslinking treatment in an appropriate order and an appropriate method. Among these, a polarizer layer formed of a polyvinyl alcohol resin film containing polyvinyl alcohol is preferable. Such a polarizer layer is capable of transmitting linearly polarized light when natural light is allowed to be incident thereon, and in particular, those having excellent light transmittance and polarization degree are preferable. The thickness of the polarizer layer is typically, but not limited to, 5 μm to 80 μm.

The pre-cut film may include an optional layer such as an adhesive layer in addition to the polarizer layer.

When the pre-cut film has a multilayer structure, it is preferable that the resin layer is disposed as an outermost layer. In addition, it is preferable that the pre-cut film is disposed so that the resin layer faces to the laser beam source, so that the film is cut by the laser beam. Thus, it is possible to effectively reduce the width of the laser processing affected portion of the cut film.

The thickness of the pre-cut film is preferably 1 μm or more, more preferably 3 μm or more, and particularly preferably 5 μm or more, and is preferably 200 μm or less, more preferably 150 μm or less, and particularly preferably 100 μm or less. When the thickness of the pre-cut film is equal to or more than the lower limit value of the aforementioned range, handling of the pre-cut film and the cut film is facilitated, when the thickness is equal to or less than the upper limit value, cutting with a laser beam is facilitated.

(Resin Layer)

The resin layer is a layer formed of a resin. The resin usually contains a polymer. As the polymer which may be contained in the resin, one type thereof may be solely used, and two or more types thereof may also be used in combination at any ratio.

Examples of the polymer which may be contained in the resin forming the resin layer may include an alicyclic structure-containing polymer, which will be described later, triacetyl cellulose, polyethylene terephthalate, and polycarbonate. Preferably in the polymer which may be contained in the resin forming the resin layer, the absorbance at a wavelength of the used laser beam when the polymer is formed as a film having a thickness of 50 μm is preferably 0.10 or less, more preferably 0.08 or less, and still more preferably 0.06 or less, and is usually 0 or more, and may be 0.01 or more.

The resin may further include an optional component other than the polymer. Examples of the optional components may include an additive such as a colorant such as a pigment and a dye; a fluorescent whitening agent; a dispersant; a plasticizer; a thermal stabilizer; a light stabilizer; an ultraviolet absorber; an antistatic agent; an antioxidant; a fine particle; and a surfactant. In addition, the resin forming the resin layer may contain a light absorber capable of absorbing the used laser beam in a range in which the advantageous effects of the production method according to the present embodiment are not inhibited.

The content ratio of the light absorber which may be contained in the resin is preferably 20% by weight or less, more preferably 15% by weight or less, and still more preferably 10% by weight or less, and is usually 0% by weight or more, and may be 0.01% by weight or more.

The resin layer is preferably a layer formed of an alicyclic structure-containing resin. The alicyclic structure-containing resin usually includes an alicyclic structure-containing polymer. The alicyclic structure-containing polymer is a polymer in which a structural unit of the polymer has an alicyclic structure.

A resin containing an aiicyclic structure-containing polymer is usually excellent in characteristics such as transparency, size stability, phase difference developability, and stretchability at low temperatures.

The alicyclic structure-containing polymer may be a polymer having an alicyclic structure in a main chain, a polymer having an alicyclic structure in a side chain, a polymer having an alicyclic structure in a main chain and a side chain, and a mixture of two or more of these at any ratio. Among these, a polymer having an alicyclic structure in the main chain is preferable from the viewpoints of mechanical strength and heat resistance.

Examples of the alicyclic structure may include a saturated alicyclic hydrocarbon (cycloalkane) structure and an unsaturated alicyclic hydrocarbon (cycloalkene, cycloalkyne) structure. Among these, from the viewpoints of mechanical strength and heat resistance, a cycloalkane structure and a cycloalkene structure are preferable. Among these, a cycloalkane structure is particularly preferable.

The number of carbon atoms constituting the alicyclic structure is preferably 4 or more, and more preferably 5 or more, and is preferably 30 or less, more preferably 20 or less, and particularly preferably 15 or less, per alicyclic structure, when the number of carbon atoms constituting the alicyclic structure is within this range, mechanical strength, heat resistance, and moldability of the alicyclic structure-containing resin are highly balanced.

In the alicyclic structure-containing polymer, the ratio of the structural unit having an alicyclic structure may be selected according to the purpose of use of the cut film. The ratio of the structural unit having an alicyclic structure in the alicyclic structure-containing polymer is preferably 55% by weight or more, more preferably 70% by weight or more, and particularly preferably 90% by weight or more. When the ratio of the structural unit having an alicyclic structure in the alicyclic structure-containing polymer is within this range transparency and heat resistance of the alicyclic structure-containing resin are favorable.

Among the alicyclic structure-containing polymers, a cycloolefin polymer is preferable. The cycloolefin polymer is a polymer having a structure obtained by polymerizing a cycloolefin monomer. The cycloolefin monomer is a compound having a ring structure formed of carbon atoms and having a polymerizable carbon-carbon double bond in the ring structure. Examples of the polymerizable carbon-carbon double bond may include a carbon-carbon double bond capable of polymerization such as a ring-opening polymerization. Examples of the ring structure of the cycloolefin monomer may include a monocycle, a polycycle, a fused polycycle, a bridged ring, and a polycycle obtained by combining these. Among these, a polycyclic cycloolefin monomer is preferable from the viewpoint of highly balanced characteristics such as dielectric characteristics and heat resistance of the resulting polymer.

Preferable examples of the aforementioned cycloolefin polymers may include a norbornene-based polymer a monocyclic olefin-based polymer, a cyclic conjugated diene-based polymer, and hydrogenated products of these. Among these, a norbornene-based polymer is particularly suitable because of its good moldability.

Examples of the norbornene-based polymer may include a ring-opening polymer of a monomer having a norbornene structure and a hydrogenated product thereof; and an addition polymer of a monomer having a norbornene structure and a hydrogenated product thereof. Examples of the ring-opening polymer of a monomer having a norbornene structure may include a ring-opening homopolymer of one type of monomer having a norbornene structure, a ring-opening copolymer of two or more types of monomers having a norbornene structure, and a ring-opening copolymer of a monomer having a norbornene structure and another monomer copolymerizable therewith. Examples of the addition polymer of a monomer having a norbornene structure may include an addition homopolymer of one type of monomer having a norbornene structure, an addition copolymer of two or more types of monomers having a norbornene structure, and an addition copolymer of a monomer having a norbornene structure and another monomer copolymerizable therewith. Among these, a hydrogenated product of a ring-opening polymer of a monomer having a norbornene structure is particularly suitable from the viewpoints of moldability, heat resistance, low hygroscopicity, size stability, and light-weight property.

In addition to the alicyclic structure-containing polymer, the alicyclic structure-containing resin may include an optional polymer other than the alicyclic structure-containing polymer. As the optional polymer other than the alicyclic structure-containing polymer, one type thereof may be solely used, and two or more types thereof may also be used in combination at any ratio.

The ratio of the alicyclic structure-containing polymer in the alicyclic structure-containing resin is ideally 100% by weight, preferably 80% by weight or more, more preferably 90% by weight or more, and particularly preferably 99% by weight or more. When the ratio of the alicyclic structure-containing polymer is equal to or higher than the lower limit value of the aforementioned range, an alicyclic structure-containing resin having a small haze can be obtained.

The absorbance of the resin layer at the wavelength of the laser beam used for cutting is preferably 0.10 or less, more preferably 0.08 or less, and still more preferably 0.06 or less, and is usually 0 or more, and preferably more than 0, and may be 0.01 or more. When the absorbance of the resin layer is within the aforementioned range, the width of the laser processing affected portion of the cut film can be effectively reduced.

The thickness of the resin layer is preferably 1 pm or more, more preferably 3 μm or more, and particularly preferably 5 μm or more, and is preferably 200 μm or less, more preferably 150 μm or less, and particularly preferably 100 μm or less. When the thickness of the resin layer is equal to or more than the lower limit value of the aforementioned range, handling of the pre-cut film and the cut film is facilitated. When the thickness is equal to or less than the upper limit value, cutting with a laser beam is facilitated.

[2. Cut Film]

According to the production method of the present embodiment, it is possible to produce a cut film that has been cut by a laser beam. The aforementioned cut film includes a resin layer, the aforementioned laser beam has a wavelength of 400 nm or longer and 850 nm or shorter, and the aforementioned cut film has an absorbance, at the wavelength of the aforementioned laser beam, of 0.10 or less.

The cut film produced by the production method of the present embodiment is a film obtained by cutting the pre-cut film, and thus examples and preferable examples of the resin layer included in the cut film and preferable ranges of properties of the cut film are the same as the examples and the preferable examples of the resin layer included in the pre-cut film and the preferable ranges of properties of the pre-cut film. Further, in a case where the pre-cut film includes an optional layer such as an adhesive layer or a polarizer layer in addition to the resin layer, the cut film also includes such an optional layer in addition to the resin layer.

The cut film produced by the production method of the present embodiment has the small width of the laser processing affected portion in the resin layer. The width of the laser processing affected portion in the resin layer of the cut film is preferably 60 μm or less, more preferably 50 μm or less, further preferably 40 μm or less, and ideally 0 μm. However, the width may be 1 μm or more.

The width of the laser processing affected portion may be measured by the following method. The cut film is cut using a microtome. In this operation, cutting with the microtome is performed so as to obtain a cross section perpendicular to the line along which the surface of the pre-cut film is scanned with the laser beam. Subsequently, the cross section cut by the microtome is observed using an optical microscope, so that a width L of the laser processing affected portion can be measured.

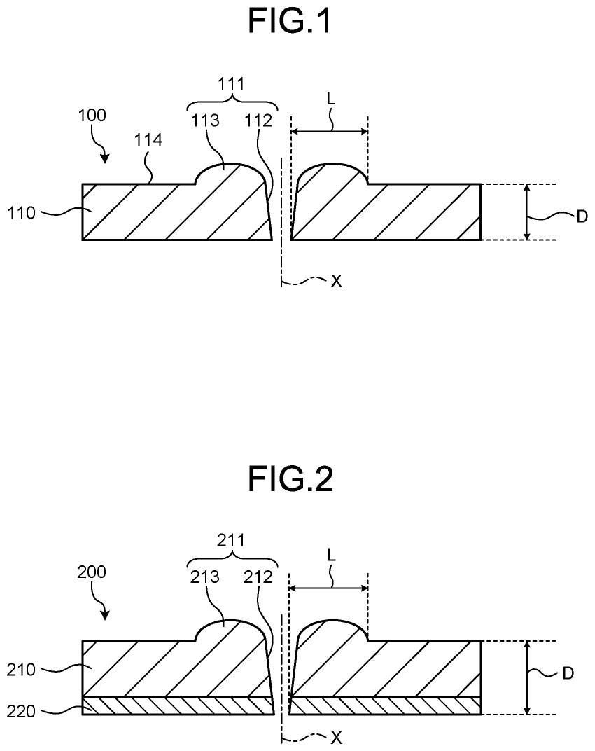

The width L of the laser processing affected portion of the cut film will be described further in detail using drawings. FIG. 1 is a cross-sectional view schematically illustrating a cut film produced from a pre-cut film including a resin layer.

In a resin layer 110 included in a cut film 100, a laser processing affected portion 111 is formed as a portion deformed by heat generated during cutting. The laser processing affected portion 111 of the resin layer 110 usually includes a cut surface 112 of the resin layer 110 and a portion 113 in which the thickness of the resin layer 110 becomes larger than before cutting in a region adjacent to the cut surface 112 of the resin layer 110. In the resin layer 110, the portion 113 in which the thickness of the resin layer 110 becomes larger than before cutting is often observed as a portion that is bulged higher than a portion 114 other than the laser processing affected portion 111.

The width L of the laser processing affected portion is a width, in a horizontal direction, of the portion affected by the laser processing in the resin layer 110 of the cut film 100 and represented by a distance from a position of the portion nearest to the center X of the cut site to a position of the portion farthest from the center X of the cut site among the portions affected by the laser processing. Specifically, the width L of the laser processing affected portion 111 is represented by the length from a position of the portion nearest to the center X of the cut site of the cut surface 112 of the resin layer 110 to the end, opposite to the cut surface 112, of the portion 113 in which a thickness D of the resin layer 110 becomes larger than before cutting.

FIG. 2 is a cross-sectional view schematically illustrating a cut film produced from a pre-cut film including a resin layer and a polarizer layer. Also, in a cut film 200 including a resin layer 210 and a polarizer layer 220, the width L of a laser processing affected portion 211 may be determined in the same manner as the cut film 100 shown in FIG. 1. Specifically, the width L of the laser processing affected portion 211 is represented by the length from a position of the portion nearest to the center X of the cut site of the cut surface 212 of the cut film 200 to the end, opposite to the cut surface 212, of a portion 213 in which the thickness D of the cut film 200 becomes larger than before cutting.

The cut film obtained in this manner may be subjected to an optional treatment as needed. Examples of such an optional treatment may include a stretching treatment, a surface treatment, and a bonging treatment with any other film.

The aforementioned cut film may be used for any use. For example, the cut film may be used as an optical film. The cut film may be used alone or in a combination with any other member. For example, the cut film may be used by being incorporated in a display device such as a liquid crystal display device, an organic electroluminescent display device, a plasma display device, a field-emission display (FED) device, or a surface-conduction electron-emitter display (SED) device. Further, the cut film may be used as a protective film of a polarizer.

[3. Film for Cut Film]

The aforementioned pre-cut film is useful for obtaining the cut film having the small width of the laser processing affected portion by performing cutting with the laser beam having a wavelength of 400 nm or longer and 850 nm or shorter. Thus, according to the present invention, there is provided a film for a cut film for obtaining the cut film by performing cutting with the laser beam having a wavelength of 400 nm or longer and 850 nm or shorter. The aforementioned film for a cut film that include a resin layer can give a cut film by being cut with the laser beam having a wavelength of 400 nm or longer and 850 nm or shorter, and has an absorbance, at the wavelength of the aforementioned laser beam, of 0.10 or less.

Examples and preferable examples of the resin layer included in the film for a cut film and preferable ranges of properties of the film for a cut film may be the same as the examples and the preferable examples of the resin layer included in the aforementioned pre-cut film and the preferable ranges of properties of the pre-cut film.

### EXAMPLES

Hereinafter, the present invention will be specifically described by illustrating Examples. However, the present invention is not limited to the Examples described below. The present invention may be optionally modified for implementation without departing from the scope of claims of the present invention and its equivalents. The following operations were performed at normal temperature and under normal pressure, unless otherwise specified.

[Evaluation Method]

### (Absorbance)

The absorbance was measured by the following method in Examples and Comparative Examples except for Comparative Example 2.

The pre-cut film was cut in a size of 20×20 mm. The absorbance of the film in the thickness direction was measured within a range of wavelengths from 200 nm to 800 nm using an ultraviolet-visible spectrophotometer (“UV-1800” manufactured by Shimadzu Corporation). Subsequently, the absorbance at the wavelength of the laser beam used for the processing was read.

In Comparative Example 2, the absorbance was measured by the following method. The pre-cut film was cut in a size of 20×20 mm, and the absorbance in the thickness direction was measured within a range of wavenumbers from 800 cm⁻¹ to 2000 cm⁻¹ using a Fourier transform-infrared spectrometer (“Spectrum Two” (trademark) manufactured by Perkin Elmer Inc.). Subsequently, the absorbance at the wavenumber of 1065 cm⁻¹ (wavelength of 9.4×10³ nm) was read.

(Measuring Method of Width of Laser Processing Affected Portion)

A sample film having a cut surface was cut using a microtome. In this operation, cutting with the microtome was performed so as to obtain a cross section perpendicular to the line scanned with the laser beam. This cross section was observed using an optical microscope to measure the width L of the laser processing affected portion.

### Example 1

### (Step for Preparing Pre-Cut Film Including Resin Layer)

An alicyclic structure-containing resin including a norbornene-based polymer (“Zeonor” manufactured by ZEON Corporation) was prepared. This alicyclic structure-containing resin was molded into a film shape using a T die-type film melt extrusion molding machine to obtain a pre-cut film consisting of only a layer (L1) of the alicyclic structure-containing resin. The conditions at the time of molding were as follows: die lip of 800 μm, T die width of 300 mm, molten resin temperature of 260° C., and cast roll temperature of 115° C. The thickness of the pre-cut film, that is, the thickness of the resin layer, was 50 μm.

The absorbance of the pre-cut film was measured by the aforementioned method.

(Cutting Step)

As a laser oscillator, a YAG (Yttrium-Aluminum-Garnet) laser device (“LVE-G1000” manufactured by Spectronix Corporation) capable of applying a laser beam of the second harmonic was prepared. A pulse laser beam having a wavelength of 532 nm, an average output (intensity) of 10 W, and a pulse width of 15 ns was applied from this laser oscillator to the aforementioned pre-cut film. In this operation, the aforementioned laser beam was applied so as to scan the surface of the pre-cut film in a straight linear manner. The pre-cut film was cut at the portion scanned with the applied laser beam. In this manner, the cut film having a cut surface was obtained.

The width L of the laser processing affected portion of the resin layer included in the cut film was measured by the aforementioned method.

### Example 2

A pre-cut film was cut by the same manner as that of Example 1 except that the following matters were changed.
The laser oscillator was changed to the YAG laser device (“LDH-1000” manufactured by Spectronix Corporation) capable of applying a laser beam of the second harmonic.
The pulse width of the laser beam was changed to 50 ps.

### Example 3

A pre-cut film was cut by the same manner as that of Example 1 except that the following matter was changed.
As the pre-cut film (resin layer), a triacetyl cellulose film having a thickness of 50 μm was used.

### Example 4

A pre-cut film was cut by the same manner as that of Example 1 except that the following matter was changed.
The pre-cut film in Example 1 was changed to the pre-cut film obtained by the following steps.

A polarizer layer (P1) was prepared. The polarizer layer (P1) is a film having a thickness of 15 μm in which iodine has been adsorbed and oriented in a polyvinyl alcohol. The layer (L1) of the alicyclic structure-containing resin as the resin layer prepared in Example 1 was bonded to one surface of the polarizer layer (P1) using an adhesive. An aqueous solution containing a polyvinyl alcohol and a water-soluble epoxy resin was used as the adhesive. In this manner, the pre-cut film including the layer (L1) of the alicyclic structure-containing resin, the adhesive layer, and the polarizer layer (P1) in this order was obtained.
The pre-cut film was disposed on the laser device with the layer (L1) of the alicyclic structure-containing resin of the pre-cut film faced toward a side of the laser beam source and cut. The average output (intensity) of the laser beam was changed to 15 W.

### Comparative Example 1

A pre-cut film was cut by the same manner as that of Example 1 except that the following matter was changed.
As the pre-cut film (resin layer), a polyimide film having a thickness of 50 μm was used.

### Comparative Example 2

A pre-cut film was cut by the same manner as that of Example 1 except that the following matters were changed.
The laser oscillator was changed to “DIAMOND E-2501” manufactured by Coherent, Inc.
The wavelength, the average output (intensity), and the pulse width of the laser beam were changed to 9400 nm, 70 W, and 100 ns, respectively.

### Comparative Example 3

A pre-cut film was cut by the same manner as that of Example 1 except that the following matters were changed
The laser oscillator was changed to “AVIA 266-3” manufactured by Coherent, Inc.
The wavelength and the average output (intensity) of the laser beam were changed to 266 nm and 3 W, respectively.

### Comparative Example 4

A pre-cut film was cut by the same manner as that of Example 1 except that the following matter was changed.
The pre-cut film in Example 1 was changed to the pre-cut film obtained by the following steps.

A polyimide film having a thickness of 50 μm as the resin layer was bonded to one surface of the polarizer layer (P1) prepared in Example 4 using an adhesive. An aqueous solution containing a polyvinyl alcohol and a water-soluble epoxy resin was used as the adhesive. In this manner, the pre-cut film including the polyimide layer, the adhesive layer, and the polarizer layer (P1) in this order was obtained.
The pre-cut film was disposed on the laser device with the polyimide layer of the pre-cut film faced toward a side of the laser beam source and cut. The average output (intensity) of the laser beam was changed to 15 W.

The results of Examples and Comparative Examples are shown in the following Tables.

The meaning of the abbreviations in the Tables is as follows:

COP: layer of alicyclic structure-containing resin

TAC: triacetyl cellulose film

COP/PVA: layered film including layer (L1) of alicyclic structure-containing resin and polarizer layer (P1)

PI: polyimide film

PI/PVA: layered film including polyimide film and polarizer layer (P1)

The column of the film thickness in the Tables indicated “thickness of resin layer/thickness of polarizer layer (P1)” in a case where the film is the layered film including the resin layer and the polarizer layer (P1).

TABLE 1

| | Example 1 | Example 2 | Example 3 | Example 4 |
|---|---|---|---|---|
| film constitution | COP | COP | TAC | COP/PVA |
| film thickness (μm) | 50 | 50 | 50 | 50/15 |
| absorbance of film at wavelength of | 0.04 | 0.04 | 0.05 | 0.06 |
| laser beam | | | | |
| laser beam | | | | |
| wavelength (nm) | 532 | 532 | 532 | 532 |
| intensity (W) | 10 | 10 | 10 | 15 |
| pulse width | 15 ns | 50 ps | 15 ns | 15 ns |
| width L of laser processing affected | 43 | 37 | 46 | 52 |
| portion (μm) | | | | |

TABLE 2

| | Comparative | Comparative | Comparative | Comparative |
|---|---|---|---|---|
| | Example 1 | Example 2 | Example 3 | Example 4 |
| film constitution | PI | COP | COP | PI/PVA |
| film thickness (μm) | 50 | 50 | 50 | 50/15 |
| absorbance of film at wavelength of | 0.12 | 0.10 | 0.21 | 0.15 |
| laser beam | | | | |
| laser beam | | | | |
| wavelength (nm) | 532 | 9400 | 266 | 532 |
| intensity (W) | 10 | 70 | 3 | 15 |
| pulse width | 15 ns | 100 ns | 15 ns | 15 ns |
| width L of laser processing affected | 70 | 105 | 58 | 83 |
| portion (μm) | | | | |

These results conclude the following.

In each of the production methods according to Examples 1 to 4, the width L of the laser processing affected portion of the obtained cut film is as small as 55 μm or less.

On the other hand, in each of the production methods according to Comparative Example 1, Comparative Example 3, and Comparative Example 4, in which the pre-cut film has an absorbance at the wavelength of the laser beam of more than 0.10, the obtained cut film has the large width L of the laser processing affected portion.

Further, in each of the production methods according to Comparative Example 3 and Comparative Example 2, in which the wavelength of the laser beam in use is shorter than 400 nm and longer than 850 nm, respectively, the obtained cut film has the large width L of the laser processing affected portion.

### REFERENCE SIGN LIST

100 cut film

110 resin layer

111 laser processing affected portion

112 cut surface

113 portion

200 cut film

210 resin layer

211 laser processing affected portion

212 cut surface

213 portion

220 polarizer layer

L width of laser processing affected portion

X center of cut site

1. A method for producing a cut film comprising cutting a pre-cut film including a resin layer with a laser beam having a wavelength of 400 nm or longer and 850 nm or shorter to obtain a cut film, wherein the pre-cut film has an absorbance, at a wavelength of the laser beam, of 0.10 or less.

2. The method for producing a cut film according to claim 1, wherein the laser beam is a second harmonic of a YAG laser device.

3. The method for producing a cut film according to claim 1, wherein the laser beam is pulsed light having a pulse width of less than 1 μs.

4. The method for producing a cut film according to claim 1, wherein the resin layer is a layer of an alicyclic structure-containing resin.

5. The method for producing a cut film according to claim 1, wherein a thickness of the pre-cut film is 200 μm or less.

6. The method for producing a cut film according to claim 1, wherein the pre-cut film further includes a polarizer layer.

7. A cut film that has been cut by a laser beam, wherein
the cut film includes a resin layer,
the laser beam has a wavelength of 400 nm or longer and 850 nm or shorter, and
the cut film has an absorbance, at the wavelength of the laser beam, of 0.10 or less.

8. The cut film according to claim 7, further comprising a polarizer layer.

9. A film for a cut film for obtaining a cut film by performing cutting with a laser beam having a wavelength of 400 nm or longer and 850 nm or shorter, wherein
the film for a cut film comprises a resin layer, and
the film for a cut film has an absorbance, at the wavelength of the laser beam, of 0.10 or less.
